(19) United States
(12) Patent Application Publication
(10) Pub. No.: US 2007/0245153 A1
(43) Pub. Date: Oct. 18, 2007

(54) System and method for user authentication in a multi-function printer with a biometric scanning device

(76) Inventors: Brent Richtsmeier, Laguna Niguel, CA (US); Mark Van Regenmorter, Lake Forest, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/406,010

(22) Filed: Apr. 18, 2006

(51) Int. Cl. H04K 1/00

(52) U.S. Cl. 713/186

(57) ABSTRACT

The invention relates to the authentication of user privileges for a multi-function peripheral (MFP) device using biometric data. A method is provided for capturing an identifying digital representation of a biometric member and comparing it to an authenticating digital representation of a biometric member saved previously. In addition to granting access to the operations of the MFP device, embodiments of the invention may be implemented that grant a user of the MFP device access to certain device privileges based on the biometric authentication. Additional layers of identifying information, including additional biometric comparisons, alphanumeric passwords/PINS, etc. are also contemplated by embodiments of the invention. Other embodiments contemplate storing the authenticating information on the MFP device, on a memory on a device in data communication with the MFP device, and on personal memory carried by the user of the MFP.

### BACKGROUND OF THE INVENTION

1. Field of the Invention

The invention relates to the operation of a multi-function peripheral (MFP) device. More particularly, the invention relates to user authorization for an MFP.

2. Description of the Related Technology

Conventional multi-function peripheral (MFP) devices implement security measures to restrict access to the device. One common measure for restricting access to an MFP employs passwords and user accounts. One disadvantage of this method of authentication is that it can be cumbersome for users who must type the usernames and passwords into a keyboard. Additionally, some MFP devices have limited keyboard capability. Another disadvantage is that MFP products must come equipped with keyboard devices, which may be separate terminals located near the device, increasing the number of units that must be serviced, or which may be integrated into the MFP devices, increasing the size and, potentially, the cost of MFP device manufacture. Hence, there is a current need for simpler entry of authentication data. Additionally, there is a need for low cost devices without keyboards that have a high level of security. Finally, some government and enterprise applications require these advantages.

### SUMMARY OF CERTAIN INVENTIVE ASPECTS

In general, aspects of the invention relate to improved authentication mechanisms for multi-function peripheral (MFP) devices. Specifically, the invention relates to using biometrics as a way to authenticate user identity in order to access the operations of a multi-function peripheral (MFP) device. In some embodiments, a fingerprint scanner is used to verify the identity of an MFP user. After authenticating the fingerprint image provided by the user, the MFP may allow access to certain device privileges authorized to the user with the corresponding fingerprint.

In one embodiment of the invention, a method of multi-finction peripheral (MFP) authentication is disclosed. The method comprises receiving an identifying digital representation of a biometric member from a prospective user of an MFP. The method further comprises comparing the identifying digital representation of the biometric member with an authenticating digital representation of the biometric member. The method further comprises permitting access to the MFP based, at least in part, on the comparison.

In another embodiment of the invention, a multi-function peripheral (MFP) device with fingerprint authentication is disclosed. The device comprises an MFP, the MFP being equipped with a fingerprint scanner, wherein the MFP is configured to communicate at least one scanned fingerprint image captured by the fingerprint scanner to an authentication module, and wherein the MFP is configured to condition access to the operations of the MFP based on an authenticating communication from the authentication module.

In another embodiment, a multi-function peripheral (MFP) device with fingerprint authentication is disclosed. The device comprises an MFP, the MFP being equipped with an authentication module, wherein the authentication module is configured to receive at least one scanned fingerprint image, is further configured to receive at least one authenticating fingerprint image, and is further configured to compare the at least one scanned fingerprint image to the at least one authenticating fingerprint image, and wherein the MFP is configured to condition access to the operations of the MFP based on the comparison.

In another embodiment, a system for restricting access to the operations of a multi-function peripheral (MFP) device based on a user's fingerprint is disclosed. The system comprises a digital fingerprint capture device, the digital fingerprint capture device configured to capture at least one digital representation of a fingerprint of a user of the MFP device. The system further comprises a memory, the memory configured to store an authenticating digital representation of the fingerprint of the user of the MFP device. The system further comprises an authentication module, the authentication module configured to compare the digital representation with the authenticating digital representation, and further configured to permit access to the operations of the MFP device based on the comparison.

### BRIEF DESCRIPTION OF THE DRAWINGS

FIG. 1 illustrates a biometric authenticating multi-function peripheral (MFP) with fingerprint authentication.

FIG. 2 illustrates a flowchart of the setup of a biometric authenticating multi-function peripheral (MFP) with fingerprint authentication.

FIG. 3 illustrates a flowchart of the operation of a biometric authenticating multi-function peripheral (MFP) with fingerprint authentication.

FIG. 4 illustrates a biometric authenticating multi-function peripheral (MFP) device with an integrated fingerprint reader.

FIG. 5 illustrates a biometric authenticating multi-function peripheral (MFP) device with an external fingerprint reader.

FIG. 6 illustrates a biometric authenticating multi-function peripheral (MFP) device with a fingerprint reader and a smart card reader.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements. The drawings, associated descriptions, and specific implementation are provided to illustrate the embodiments of the invention and not to limit the scope of the disclosure.

In general, the invention relates to methods, systems, and software for implementing user authentication in a multi-function peripheral (MFP) device with a biometric scanning device. (MFP devices are defined in more detail immediately below.) There are many instances when system administrators and others may desire to implement user authentication with MFP devices through the use of biometric scanning devices. Existing authentication techniques for MFP devices do not include biometric authentication. One purpose of the invention is to provide enhanced MFP authentication services so that a user of an MFP may be authenticated with a biometric device.

The phrase capture device may refer to a device capable of capturing a digital representation. Thus, optical scanners, capacitive scanners, digital cameras, combinations of the same and the like may be capture devices. This application is concerned with biometric capture devices. Thus, a device capable of capturing a digital representation of biometric data may appropriately be considered a capture device. For instance, an optical fingerprint scanner is an example of a capture device.

The phrase digital representation may refer to a way of representing a material object in digital form, that is, as a collection of electronic bits. This application often refers to digital representations in the context of capture devices that capture representations of biometric data. Capture devices may be configured to generate a digital representation of the thing captured, such as a digital image of a fingerprint.

A multi-function peripheral (MFP) device is a single integrated device configured to perform two or more functions, including without limitation scanning, copying, printing, faxing, combinations of the same and the like. The functionality of an MFP device may be accessed over a network, including, for example, the Internet or a LAN, or at the device itself. A MFP device may be configured with sufficient memory to queue jobs waiting to be processed. It will be appreciated that MFP devices may be configured to perform in a variety of different networked and standalone computing environments.

Although the following embodiments discuss the invention with reference to an MFP device, the invention is not limited to MFP devices, as the enhanced notification services may also be applied to single-function peripheral devices as well. Moreover, embodiments of a biometric authenticating MFP may also include an aggregate of single-function peripheral devices that may perform one or more functions.

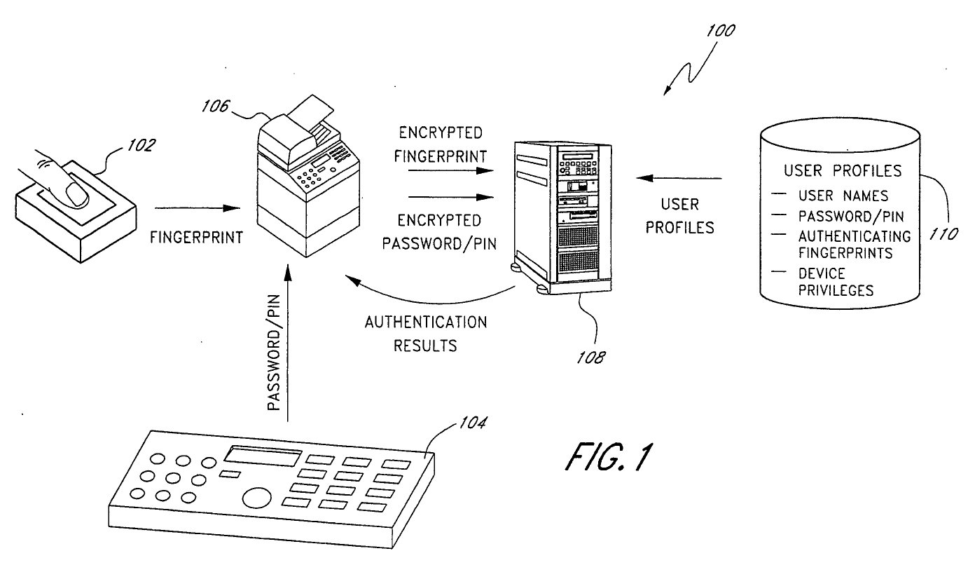

FIG. 1 illustrates a biometric authenticating multi-function peripheral (MFP) 100 with fingerprint authentication. In the illustrated embodiment, a fingerprint scanner 102 and an alphanumeric interface 104 provide user identifying information to an MFP device 106. The MFP device 106 communicates with an authenticating module 108, which has access to a memory 110 that stores authenticating user information in stored user profiles.

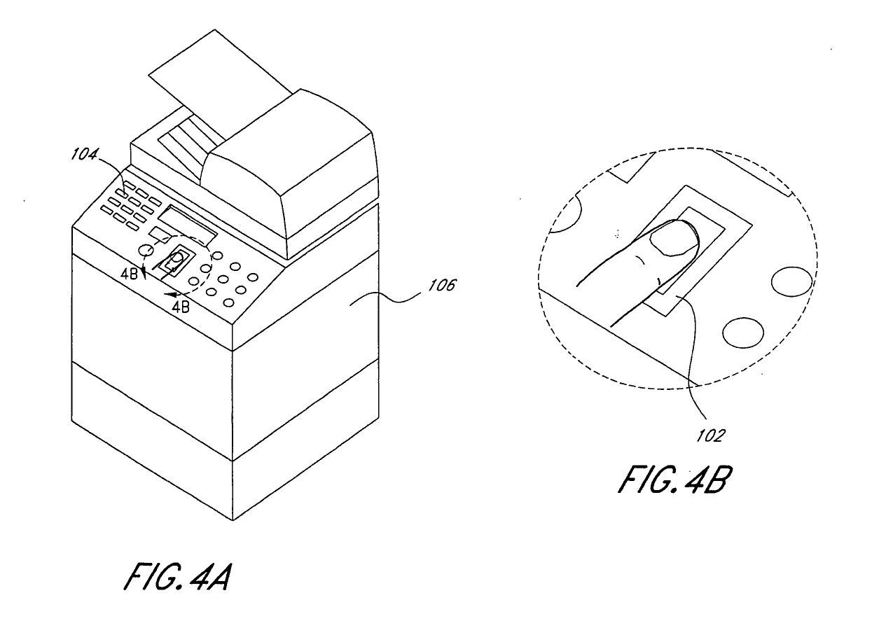

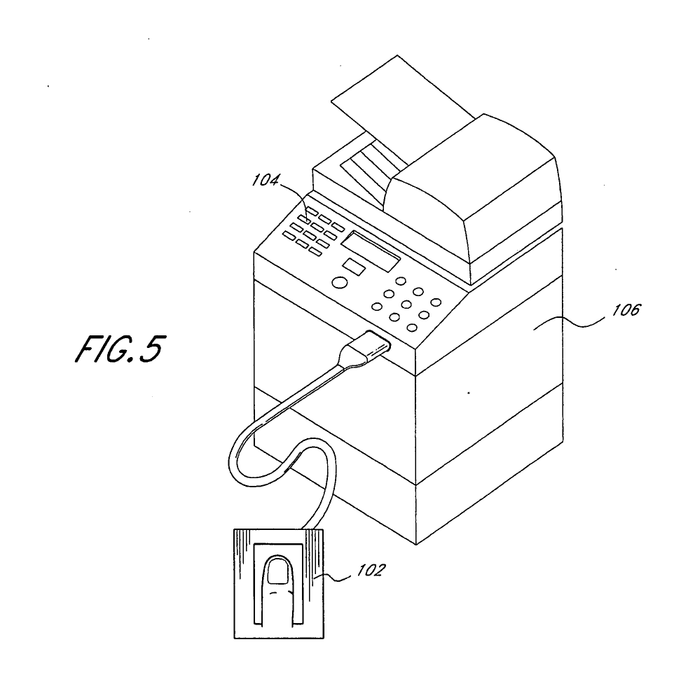

In particular, a biometric authenticating MFP device 100 may provide a fingerprint interface 102. A perspective user of the biometric authenticating MFP 100 may place a finger onto the fingerprint interface 102, which may be any device capable of capturing a digital representation of a fingerprint. For instance, the fingerprint interface 102 may be, for instance, an optical scanner or a capacitance scanner. One skilled in the art will appreciate that there are many ways in which a fingerprint interface may be designed. In certain embodiments, the fingerprint interface 102 may be integrated into the MFP 106 (as illustrated in FIG. 4). In other embodiments, the fingerprint interface 102 may exist as a standalone device separate from the housing of the MFP 106 (as illustrated in FIG. 5). As a standalone device, the fingerprint interface 102 may communicate with the MFP 106 through wired and/or wireless communication. For instance, the fingerprint interface 102 may be connected to the MFP 106 via a USB cable connection (as illustrated in FIG. 5). In other embodiments, the fingerprint interface 102 may communicate with the MFP 106 through Bluetooth, WiFi®, radio frequency, or other wireless means of communication.

The alphanumeric interface 104 may provide secondary identifying information to the MFP 106. Through the alphanumeric interface 104, a user may enter usernames, passwords, and/or PIN numbers. Once again, it will be appreciated that there are many ways to implement an alphanumeric interface for an MFP device, such as the MFP 106. Similar to the fingerprint interface 102, the alphanumeric interface 104 may communicate with the MFP 106 through either wired and/or wireless communication. In the embodiment illustrated in FIGS. 4 and 5, the alphanumeric interface 104 is built into the housing of the MFP 106.

In other embodiments, the secondary identifying information provided by the user through the alphanumeric interface 104 may not be used, and the biometric authenticating MFP device 100 may not be equipped with the alphanumeric interface 104. Alternatively, the secondary identifying information may not be used, but the alphanumeric interface 104 may be provided for other functions.

In other embodiments, other interfaces may be used to provide secondary identifying information, such as another biometric device, including a voice pattern recognition program or an iris pattern scanner. It will be appreciated by one skilled in the art that there are many ways to provide secondary identifying information. One skilled in the art will also appreciate that additional information may be used to authenticate a user, including tertiary identifying information, quaternary identifying information, etc. Additional alphanumeric, biometric, or other interface devices may be added as desired.

In the illustrated embodiment, the MFP 106 may encrypt the digital representation of the fingerprint and the secondary identifying information provided by the alphanumeric interface 104. In other embodiments, the fingerprint interface 102 may encrypt the digital representation of the fingerprint before communicating it to the MFP 106. Similarly, the alphanumeric interface may encrypt the secondary identifying information before sending it to the MFP 106. Additionally or alternatively, another device dedicated to encrypting information may provide the encryption. The encryption may be a standard encryption scheme in the industry or may be a proprietary scheme. The encryption scheme may be different for the digital representation of the fingerprint and for the secondary identifying information; that is, separate encryption schemes may be used for each form of identifying information. Once again, one skilled in the art will appreciate that there are many ways to encrypt data for secured transfer within systems or networks.

In the illustrated embodiment, the authentication module 108 is responsible for determining whether the digital representation of the fingerprint and the secondary identifying information submitted by the user match the respective authenticating information in the stored user profiles. In some embodiments, the authentication module 108 may reside on the MFP device 106. In other embodiments, the identification module 108 may be implemented on a separate computing device connected to the MFP 106 via a network, such as the Internet. Once again, one skilled in the art will appreciate that there are many ways to configure separate computing devices to communicate with one another over a network, including LAN, Internet, etc. The authentication module 108 may be a microprocessor with a dedicated instruction set. Alternatively, the authentication module may be machine loadable software instructions. One skilled in the art will appreciate that there are many ways to perform the comparison of biometric data, as well as the comparison of other identifying information.

In some embodiments, authenticating information may be stored in individual user profiles stored in a memory, such as the memory 110. Each individual user profile may comprise various information. For instance, a user profile may comprise a username, password/PIN, authenticating fingerprint images, other biometric data, and a list of device privileges authorized to the user. This information may be stored separately for each prospective user of the MFP 106. This data may be organized with reference to a unique identifier for the user, such as a unique username or even biometric data, including a fingerprint image. User profiles may also be stored in a relational database or in other searchable data structures. One skilled in the art will appreciate that there are many ways to save and store user data that may be accessed by software programs or dedicated devices.

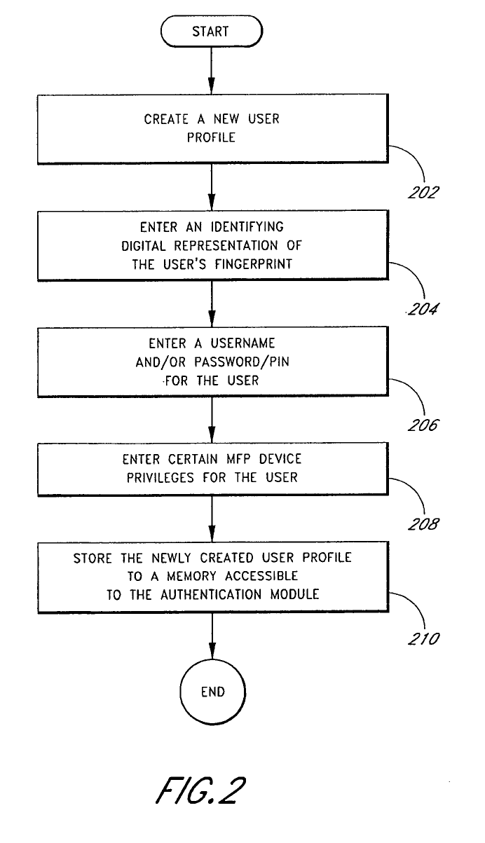

FIG. 2 illustrates a flowchart of the setup of a biometric authenticating multi-function peripheral (MFP) with fingerprint authentication. In the illustrated embodiment, the system administrator creates a new user profile using software that is capable of storing the profiles to a memory accessible to the authentication module 108, such as the memory 110. The software may be a part of the authentication module 108; thus, the authentication module 108 may provide a user interface for storing the authenticating information that is used to determine whether the user is authorized to use the MFP 106. The setup software may reside on a server computer on a computing device that communicates with the MFP 106. Alternatively, the setup software may reside on the MFP 106, and the system administrator may access the authentication module software via the alphanumeric interface 104 of the MFP 106 (or some other suitable interface). Additionally, the system administrator may access authentication module software embedded in the MFP 106 via a web browser. As mentioned with reference to FIG. 1, the user profile may consist of various data fields. Alternatively, the user profile may represent a single field, such as the digital representation of a user's fingerprint. One skilled in the art will appreciate that there are many ways to organize the information.

In state 202, the system administrator creates a new user profile using the setup software. In states 204 through 208, the system administrator enters additional information into the fields of the newly created user profile. In state 204, the system administrator enters the authenticating digital representation of the respective user's fingerprint. The system administrator may enter this digital representation of the user's fingerprint by providing a previously stored image of the user's fingerprint. Alternatively, the system administrator may require the prospective user to provide their finger at the time that the user profile is created. In some embodiments, the user may initiate the creation of a user's profile by accessing the setup software directly. In these cases, the user may supply some kind of authenticating information to access the setup software as an administrator.

In state 206, the system administrator enters a username and/or password/PIN corresponding to the user. The username may be a unique identifier for the user. The password/PIN may be used as secondary identifying information. In other embodiments, the username may also be used as secondary identifying information. One skilled in the art will appreciate that there are many alphanumeric combinations that may be used for either uniquely identifying a user profile or for providing secondary identifying information to a biometric authenticating MFP device 100.

In state 208 the system administrator enters certain MFP device privileges for the corresponding user. A device privilege is an operation that a particular user is authorized to access on a given MFP device. For instance, a user may be authorized to use the printing and copying operations of a MFP, but not the faxing and/or scanning functions. Additionally, user privileges may refer to function-specific features of a MFP. For instance, a user may be authorized to use the black/white feature of the copying and printing functions, but not the color features of the copying and/or printing functions. One skilled in the art will appreciate that there are many different ways to specify device privileges and to organize them into a user profile.

In state 210 the system administrator stores the newly created user profile to a memory accessible to the authentication module 108. For instance, the system administrator may store the newly created user profile to a local memory on the computing device that contains the setup software. This computing device may be accessible to the MFP 106 via a network connection. Alternatively, the system administrator may save the newly created user profile to a memory residing on the MFP 106. In some embodiments, the system administrator may send the newly created user profile to the MFP 106 via e-mail, fax, FTP, etc. In yet other embodiments, the system administrator may cause that the newly created user profile is stored to a portable media. This media may be, for instance, a smart card. This media, such as a smart card, may be carried regularly by a prospective user of the biometric authenticating MFP device 100.

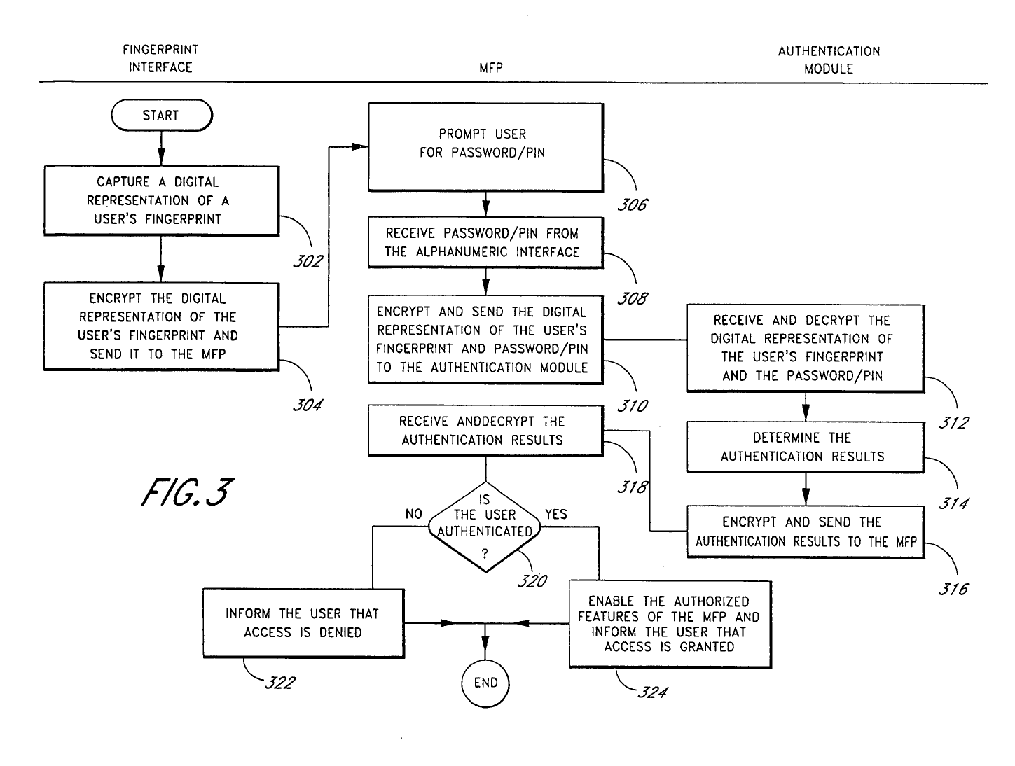

FIG. 3 illustrates a flowchart of the operation of a biometric authenticating multi-finction peripheral (MFP) with fingerprint authentication. FIG. 3 is divided into three sets of operations carried out by, respectively, the fingerprint interface 102, the MFP 106, and the authentication module 108. In state 302, a fingerprint interface 102 captures a digital representation of the user's fingerprint. As mentioned above, the digital representation of a user's fingerprint is electronically stored data that may be used to identify a unique fingerprint pattern. The fingerprint interface 102 may capture, for instance, an image, such as when the fingerprint interface 102 is an optical or capacitance scanner. One skilled in the art will recognize that there are other devices capable of capturing a scanned image including, for example, digital cameras and camcorders.

In state 304, the fingerprint interface 102 encrypts the digital representation of the user's fingerprint and sends it to the MFP 106. The form of encryption may be any suitable standard form of encryption, or may be a proprietary scheme. The encrypted digital representation may be sent via wired or wireless connection to the MFP. One skilled in the art will appreciate that there are many encryption and data communication methods that may be employed. In some embodiments, digital representation may not be encrypted, for instance where time and/or encryption resources are constrained. In other embodiments, the encryption may occur at the MFP 106. In other embodiments, the fingerprint reader is integrated into the MFP 106, and the “sending” of the digital representation to the MFP 106 merely comprises saving the digital representation in a memory accessible to the MFP 106. One skilled in the art will appreciate that there are many different ways to configure/integrate a fingerprint reader with a MFP 106. For instance, the fingerprint reader may be connected via a USB cable (as illustrated in FIG. 5) or integrated directly into the MFP device (as illustrated in FIG. 4).

Upon receiving the encrypted digital representation of the user's fingerprint, the MFP 106 prompts the user for a password/PIN through the alphanumeric interface 104. A password/PIN may serve as secondary identifying information. There are several reasons for using an additional layer of security, including false positives that may arise with fingerprint technology and enhanced security through multiple layers of checking. The alphanumeric interface 104 may be integrated into the control panel of the MFP 106, or may be implemented as a standalone device. The alphanumeric interface may comprise numbers and/or letters. It will be appreciated by one skilled in the art there are many ways to implement an alphanumeric interface of an MFP. In another embodiment, the secondary identifying information may be provided by input other than through the alphanumeric interface 104. For instance, a second biometric capture device may be used to gather additional biometric information, such as voice recognition software or iris pattern scanners. Additionally, in some embodiments, secondary identifying information may not be provided, and authentication relies on the first biometric data only. However, in other embodiments, tertiary, quaternary, etc. identifying information may be gathered, including multiple biometric and/or alphanumeric identifiers.

In state 308, the MFP 106 receives and encrypts the alphanumeric password/PIN. As mentioned, with reference to the encryption of the identifying digital representation of the user's fingerprint, the encryption of the alphanumeric password/PIN may be any encryption scheme, including proprietary schemes. Alternatively, the MFP 106 may receive the alphanumeric password/PIN without any encryption.

In state 310, the MFP 106 encrypts and sends the digital representation of a user's fingerprint and password/PIN to the authentication module 108. It will be appreciated that the MFP 106 and the authentication module 108 may be connected through either wired or wireless communication. In some embodiments, the MFP 106 and authentication module 108 may reside on the same device, such as the MFP 106. The authentication module 108 may be software installed on the MFP 106 or may be a dedicated logic device running on the MFP 106. One skilled in the art will appreciate that there are many ways to implement the authentication module 108 including, software, firmware, or any way in which to instruct a MFP. In certain embodiments, the MFP 106 and the authentication module 108 reside on separate devices. For instance the authentication module 108 may reside on a server computer. The MFP 106 may communicate with the authentication module 108 residing on a server computer through a network (not illustrated). In other embodiments, the authentication module 108 may communicate with the MFP 106 through various means of communication, such as email, fax, FTP, etc. In other embodiments, the authentication module may reside on a device carried by the user of the biometric authentication MFP device 100. For instance, a user may carry the authentication module on a smart card or a personal digital assistant (PDA). In such a case, the MFP 106 may communicate with the authentication module 108 through a variety of different connections. For instance, the MFP 106 may be equipped with a smart card reader or, alternatively, have a smart card reader connected to it.

In state 312 the authentication module 108 receives and decrypts the digital representation of the user's fingerprint and the password/PIN. It will be appreciated by one skilled in the art that there are many means for decrypting, such as a public and/or private key system. Additionally, there may be certain handshaking routines that must occur between the MFP 106 and the authentication module 108.

In state 314, the authentication module 108 determines the authentication results based on the identifying information provided by the user and the authentication information stored to a memory accessible to the authentication module 108 during the setup procedure (as described in the flowchart illustrated in FIG. 2). One skilled in the art will appreciate that there are many ways to compare digital representations of a fingerprint to determine whether or not the identifying digital representation of the user's fingerprint and the stored authenticating digital representation of the user's fingerprint represent the same fingerprint. The authentication module 108 may access a memory storing the authentication information. As illustrated in FIG. 1, the memory may include user profiles, storing information such as usernames, password/PIN, authenticating digital representations of a user's fingerprint, and device privileges authorized to the user. The authentication module 108 may access this authentication information in order to determine whether or not the identifying information corresponds to an authorized user. In certain embodiments, the user profile may consist merely of an authenticating digital representation of a user's fingerprint. If the authentication module 108 determines that none of the saved authenticating digital representations of the fingerprint matches the identifying digital representation of the user's fingerprint, then the authentication module 108 may determine that the user is not authorized to access the biometric authenticating MFP 100.

In other embodiments, user profiles may contain more than just the authenticating digital representation of a user's fingerprint. For instance, profiles may contain usernames and/or password/PINs. In these embodiments, the usernames may be used as an additional level of security or for convenience in searching for the matching digital representations of the user's fingerprints. Similarly, passwords and/or PINs may be used to provide additional levels of security. For instance, in some embodiments, a password/PIN may be used as a secondary identifying information. In some embodiments, the authentication is performed in a two-tiered structure. For instance, the authentication module 108 first checks for an authenticating digital representation of the user's fingerprint that matches the identifying digital representation of the user's fingerprint. Once it has been determined that there is a successful match of the fingerprint, the authentication module 108 may then determine whether or not the identifying secondary information matches the secondary authenticating information corresponding to the user identified by the matching fingerprint. In other embodiments, the authentication module 108 may first check for any secondary authentication information and then determine whether or not the digital representations of the user's fingerprint are appropriate matches. In still other embodiments, these comparisons may take place simultaneously. Additionally, tertiary, quaternary, etc. layers of authentication may be used to verify and/or authenticate a user's identity.

In state 316, once the authentication module 108 has determined the authentication results, the authentication module 108 encrypts and sends the authentication results to the MFP 106. Authentication results may comprise different elements. The authentication results may comprise a simple Boolean value indicating whether or not the user is authorized to use the biometric authenticating MFP 100. In other embodiments, the authentication results may additionally contain a list of device privileges authorized to a user. Alternatively, the authentication results provide information that unlocks device privileges stored on the MFP 106. One skilled in the art will appreciate that there are many ways to provide memory and processing components in various configurations to implement a system for specifying device privileges once authentication has occurred.

In state 318, MFP 106 receives and encrypts authentication results. In the illustrated embodiment, in state 320, the MFP 106 may take one of two actions following the receipt of the authentication results. In state 322, MFP 106 informs the user that access is denied, if the user is not authenticated. In state 324, the MFP 106 enables the authorized features of the MFP and informs the user that access is granted.

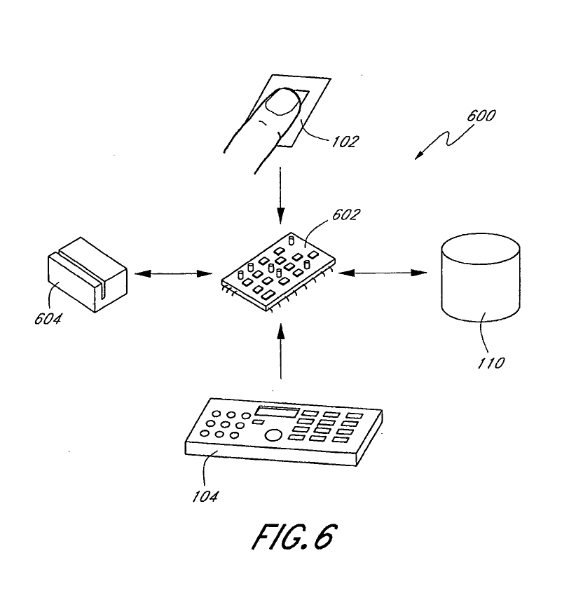

FIG. 6 illustrates a biometric authenticating multi-finction peripheral (MFP) device with a fingerprint reader and a smart card reader. The embodiment in FIG. 6 may be implemented with the setup and operation processes described in FIGS. 2 and 3, respectively. The embodiment in FIG. 6 includes an additional hardware feature, the smart card reader. As mentioned above with reference to FIG. 3, the smart card reader may be configured to read the authenticating information from a smart card that the user must carry to access the device. During the setup process, described in FIG. 2, the system administrator may save an authenticating image of the user's fingerprint on the memory contained in the smart card. An MFP, such as the MFP 106, may be equipped with a smart card reader 604. (In FIG. 6, the microprocessor 602 generally represents the processing features performed by the MFP 106 described with reference to FIGS. 1 through 3.) In this case, it may be unnecessary to access the memory 110, as the user's smart card may contain all of the authenticating information. Alternatively, the smart card may contain only the authenticating digital representation of the user's fingerprint and the memory 110 may contain the authenticating secondary information, or vice versa. Moreover, the smart card may contain identifying information, such as the identifying secondary information, or even the identifying digital representation of a user's fingerprint.

Although this invention has been described in terms of certain embodiments, other embodiments that are apparent to those of ordinary skill in the art, including embodiments which do not provide all of the benefits and features set forth herein, are also within the scope of this invention. Accordingly, the scope of the present invention is defined only by reference to the appended claims.

What is claimed is:

1. A method of multi-function peripheral (MFP) authentication, the method comprising:
receiving an identifying digital representation of a biometric member from a prospective user of an MFP;
comparing the identifying digital representation of the biometric member with an authenticating digital representation of the biometric member; and
permitting access to the MFP based, at least in part, on the comparison.

2. The method of claim 1, wherein the biometric member is a fingerprint.

3. The method of claim 1, wherein receiving an identifying digital representation comprises receiving a digital representation captured at approximately the same time as receipt.

4. The method of claim 1, wherein receiving an identifying digital representation comprises receiving an image from a scanner.

5. The method of claim 1, wherein receiving an identifying digital representation comprises receiving a saved digital representation captured at a different time than receipt.

6. The method of claim 1, wherein receiving an identifying digital representation comprises receiving a saved image from a smart card reader.

7. The method of claim 1, wherein the authenticating digital representation of the biometric member comprises a digital representation of the biometric member stored in a memory.

8. The method of claim 7, wherein the memory is located on a device carried by the prospective user.

9. The method of claim 7, wherein the memory is located on a device connectible to the MFP device by either wired or wireless communication.

10. The method of claim 7, wherein the memory is located on the MFP device.

11. The method of claim 1, wherein permitting access to the MFP comprises permitting access to the MFP if the identifying digital representation of the biometric member from the prospective user is sufficiently similar to the authenticating digital representation of the biometric member to conclude that the two digital representations correspond to the same physical biological member.

12. The method of claim 1, wherein permitting access to the MFP comprises permitting access to a set of user privileges for operating the MFP.

13. The method of claim 1, further comprising receiving secondary identification information from the prospective user of the MFP, and further comprising comparing the secondary identification information with secondary authentication information, and further comprising permitting access to the MFP based, at least in part, on the secondary comparison.

14. The method of claim 13, wherein the secondary identification information is one of the following: username, password, PIN, or combination of the same.

15. The method of claim 13, wherein permitting access to the MFP based, at least in part, on the comparison comprises enabling the receipt of the secondary identification information from the prospective user of the MFP.

16. The method of claim 13, wherein permitting access to the MFP based, at least in part, on the secondary comparison, comprises enabling the receipt of the fingerprint image from the perspective user of the MFP.

17. A multi-function peripheral (MFP) device with fingerprint authentication, the device comprising:
an MFP, the MFP being equipped with a fingerprint scanner, wherein the MFP is configured to communicate at least one scanned fingerprint image captured by the fingerprint scanner to an authentication module, and wherein the MFP is configured to condition access to the operations of the MFP based on an authenticating communication from the authentication module.

18. The system of claim 17, wherein the authentication module is a set of instructions executed on a device in data communication with the MFP.

19. The system of claim 17, wherein the authentication module is a set of instructions executed on a component of the MFP.

20. The system of claim 17, wherein the MFP is configured to communicate with the authentication module via either or both wired and wireless communication.

21. A multi-function peripheral (MFP) device with fingerprint authentication, the device comprising:
an MFP, the MFP equipped with an authentication module, wherein the authentication module is configured to receive at least one scanned fingerprint image, is further configured to receive at least one authenticating fingerprint image, and is further configured to compare the at least one scanned fingerprint image to the at least one authenticating fingerprint image, and wherein the MFP is configured to condition access to the operations of the MFP based on the comparison.

22. The system of claim 21, wherein the at least one scanned fingerprint image is received from a fingerprint scanner in data communication with the MFP.

23. The system of claim 22, wherein the fingerprint scanner is embedded within the MFP.

24. The system of claim 21, wherein the at least one authenticating fingerprint image is stored in a memory residing on the MFP.

25. The system of claim 21, wherein the at least one authenticating fingerprint image is stored in a memory residing on a device configured to communicate with the MFP, and wherein the MFP is configured to communicate with the device.

26. The system of claim 25, wherein the device configured to communicate with the MFP is a smart card, and wherein the MFP being configured to communicate with the device comprises the MFP being equipped with a smart card reader.

27. The system of claim 25, wherein the device configured to communicate with the MFP is a computing device, and wherein the MFP being configured to communicate with the device comprises the MFP being connected with the computing device via a network.

28. A system for restricting access to the operations of a multi-function peripheral (MFP) device based on a user's fingerprint, the system comprising:
a digital fingerprint capture device, the digital fingerprint capture device configured to capture at least one digital representation of a fingerprint of a user of the MFP device;
a memory, the memory configured to store an authenticating digital representation of the fingerprint of the user of the MFP device; and
an authentication module, the authentication module configured to compare the digital representation with the authenticating digital representation, and further configured to permit access to the operations of the MFP device based on the comparison.

29. The system of claim 28, wherein the digital fingerprint capture device is a fingerprint scanner.

30. The system of claim 28, wherein the digital fingerprint capture device is a digital camera.

31. The system of claim 28, wherein the memory resides on a device configured to communicate with the MFP device, and wherein the MFP device is configured to communicate with the device.

32. The system of claim 31, wherein the device configured to communicate with the MFP device is a computing device, and wherein the MFP being configured to communicate with the device comprises the MFP being connected with the computing device via a network.

33. The system of claim 31, wherein the device configured to communicate with the MFP device is a smart card, and wherein the MFP device being configured to communicate with the device comprises the MFP being equipped with a smart card reader.

34. The system of claim 28, wherein the memory resides on the MFP device.

35. The system of claim 28, wherein the authentication module resides on a device configured to communicate with the MFP device.

36. The system of claim 35, wherein the device configured to communicate with the MFP device is a computing device configured to communicate with the MFP device via a network.

37. The system of claim 28, wherein the authentication module resides on the MFP device.

38. The system of claim 28, further comprising a secondary identification interface, the secondary identification interface configured to receive secondary identification information.
